(19) United States
(12) Patent Application Publication
(10) Pub. No.: US 2019/0156254 A1
(43) Pub. Date: May 23, 2019

(54) SYSTEMS AND METHODS FOR DYNAMICALLY MANAGING A SHUTTLE FLEET

(71) Applicant: GM Global Technology Operations LLC, Detroit, MI (US)

(72) Inventors: Gregg M. HANSEN, Austin, TX (US); Jose J. AVILA BAYLON, Round Rock, TX (US); Geoffrey J. RUSSEL, Austin, TX (US)

(73) Assignee: GM Global Technology Operations LLC, Detroit, MI (US)

(21) Appl. No.: 15/819,853

(22) Filed: Nov. 21, 2017

(51) Int. Cl. G06Q 10/06; G06Q 10/02

(52) U.S. Cl. CPC G06Q 10/0631; G06Q 10/02

(57) ABSTRACT

Systems and Methods for dynamically managing a shuttle fleet are provided. In one example, a system includes a communications module, a shuttle assignment module, and a reservation confirmation module. The communications module may be configured to obtain a shuttle reservation request, shuttle information, and transportation network state information. The shuttle assignment module may be configured to generate shuttle route information based on the shuttle reservation request, the shuttle information, and the transportation network state information. The reservation confirmation module may be configured to determine a projected destination arrival time based on the shuttle reservation request, the shuttle information, and the transportation network state information. In addition, the reservation confirmation module may be configured to generate a reservation confirmation including the projected destination arrival time for transmission via the communications module.

### INTRODUCTION

The introduction provided here is for the purpose of generally presenting the context of the disclosure. Work of the presently named inventors, to the extent it is described in this introduction section as well as other aspects of the description are neither expressly nor impliedly admitted as prior art against the present disclosure.

The present disclosure relates to systems and methods for managing shuttles included as part of a shuttle service and, more particularly, to systems and methods for optimizing shuttle routing based on target destination arrival time.

Shuttle and shared ride systems allow users to request transportation from a pick-up location to a drop-off location. These systems typically include a fleet of human-operated shuttles (e.g., cars, vans, buses, bicycles, motorcycles, etc.) that are utilized to service the users' transportation requests.

Shuttle and shared ride systems determine which shuttle to assign to satisfy a particular transportation request based on one or more of the following criteria: (i) proximity between the requested pick-up location and the shuttles and/or (ii) a projection of how quickly the shuttles can reach the pick-up point associated with the transportation request. Typically, the shuttle that can reach the pick-up location associated with the transportation request in the shortest amount of time is the shuttle that is assigned to service the transportation request.

### SUMMARY

In a feature, a system is provided. The system may include a communications module, a shuttle assignment module, and a reservation confirmation module. The communications module may be configured to obtain a shuttle reservation request, shuttle information, and transportation network state information. The shuttle reservation request may be obtained from a user device and may include a target destination arrival time, a pick-up location, and/or a destination location. The shuttle information may be obtained from each shuttle in a shuttle fleet and may include identity information, location information, and occupancy information associated with each shuttle in the shuttle fleet. The transportation network state information may include traffic information and weather information associated with a geographic region encompassing the pick-up location. The shuttle assignment module may be configured to generate shuttle route information based on the shuttle reservation request, the shuttle information, and the transportation network state information. The shuttle route information may include an instruction directing a shuttle to pick-up a passenger at the pick-up location and transport the passenger to the destination location by the target destination arrival time. The reservation confirmation module may be configured to determine a projected destination arrival time based on the shuttle reservation request, the shuttle information, and the transportation network state information. In addition, the reservation confirmation module may be configured to generate a reservation confirmation including the projected destination arrival time. The communications module may be configured transmit the shuttle route information to the shuttle and transmit the reservation confirmation to the user device.

In another feature, the system includes a buffer generation module. The buffer generation module may be configured to obtain the shuttle route information and the transportation network state information and generate a buffer time based on the shuttle route information and the transportation network state information. In one example of the foregoing feature, the reservation confirmation module is further configured to determine the projected destination arrival time based on the buffer time. In yet another example of the foregoing feature, the buffer generation module is further configured to generate an updated buffer time based on a change to the shuttle route information and/or the transportation network state information. In one example of the foregoing feature, the reservation confirmation module is further configured to determine an updated projected destination arrival time based on the updated buffer time and generate an updated reservation confirmation. The updated reservation confirmation may include the updated projected destination arrival time. In another example of the foregoing feature, wherein the communication module may be further configured to transmit the updated reservation confirmation to the user device.

In one feature, the shuttle information includes seating configuration information describing possible seating arrangements associated with each shuttle in the shuttle fleet. In one example of the foregoing feature, the shuttle assignment module may be further configured to generate the shuttle route information based on the seating configuration information.

In another feature, the transportation network state information also includes fixed route transportation state information describing respective statuses of vehicles included within a fixed route transportation network associated with the geographic region encompassing the pick-up location.

In one feature, the shuttle includes an autonomous vehicle. In this feature, the shuttle route information may be configured to cause the autonomous vehicle to pick-up a passenger at the pick-up location and transport the passenger to the destination location by the target destination arrival time.

In a feature, the shuttle assignment module may be further configured to select a particular shuttle from the shuttle fleet to satisfy the reservation request based on the shuttle reservation request, the shuttle information, and/or the transportation network state information.

In another feature, the reservation confirmation further includes assigned shuttle identify information. The assigned shuttle identify information may include information identifying a particular shuttle from the shuttle fleet assigned to satisfy the reservation request

In one feature, the reservation confirmation further includes pick-up location confirmation information. The pick-up location confirmation information may include at least one of a textual and visual representation of the pick-up location.

In a feature, the reservation confirmation module may be further configured to determine an updated projected destination arrival time based on a change to the shuttle reservation request, the shuttle information, and/or the transportation network state information. In one example of the foregoing feature, the reservation confirmation module may be further configured to generate an updated reservation confirmation. The updated reservation confirmation may include the updated projected destination arrival time. In another example of the foregoing feature, the communications module may be further configured to transmit the updated reservation confirmation to the user device.

In one feature, the shuttle assignment module may be further configured to generate updated shuttle route information based on a change to the shuttle reservation request, the shuttle information, and/or the transportation network state information.

In another feature, the communication module may be further configured to transmit the updated shuttle route information to the shuttle.

In a feature, the system further includes the shuttle.

In another feature, the system further includes the shuttle fleet.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a network diagram illustrating an example of a system for managing a shuttle fleet;

FIG. 2 is a functional block diagram illustrating an example of a computing device for managing a shuttle fleet;

FIG. 3 is a functional block diagram illustrating an example of a system for managing a shuttle fleet, and including another example of a computing device for use within the system;

FIG. 4 is a diagram illustrating an example of a user device including a graphical user interface (GUI) configured to obtain a shuttle reservation request;

FIG. 5 is a diagram illustrating an example of a user device including a GUI configured to confirm a shuttle reservation request and provide a projected destination arrival time;

FIG. 6. is a state diagram and accompanying tables illustrating an example of a process for managing multiple shuttle reservation requests; and

FIG. 7 is a flowchart illustrating an example method for managing a shuttle fleet.

In the drawings, reference numbers may be reused to identify similar and/or identical elements.

### DETAILED DESCRIPTION

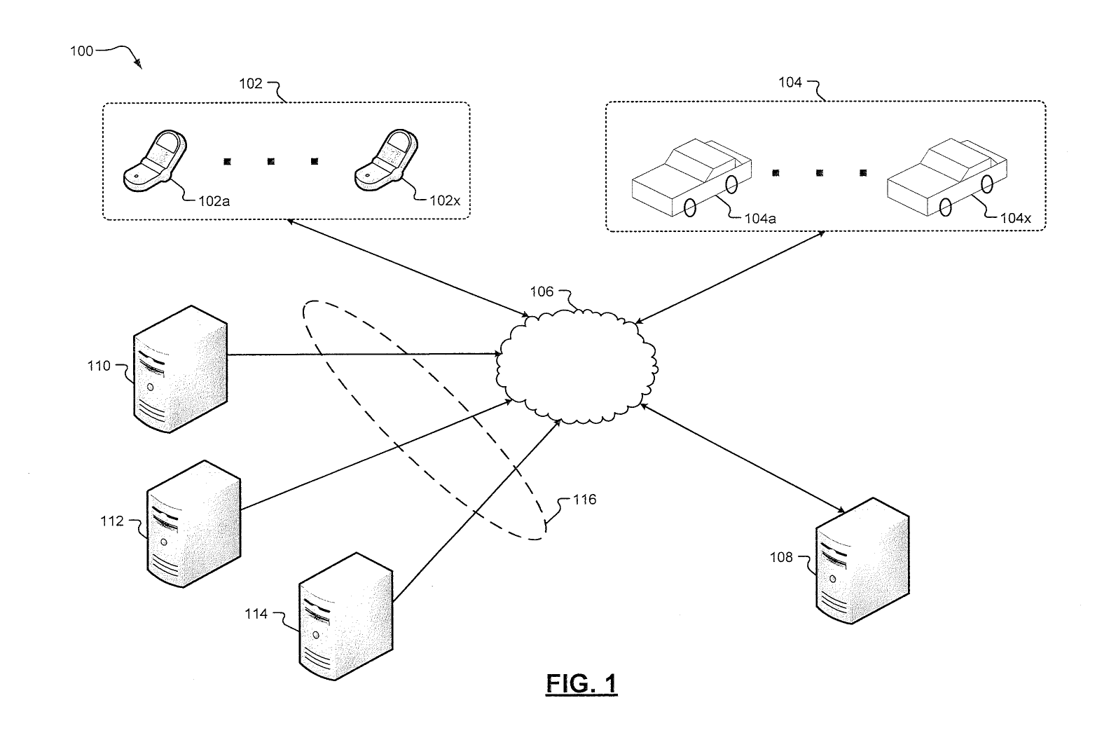

Referring now to FIG. 1, a system 100 for managing a fleet of shuttles 104 is shown. The system 100 includes one or more user devices 102, the fleet of shuttles 104, a shuttle management computing device 108, a roadway traffic computing device 110, a weather computing device 112, and a fixed route transportation network computing device 114. The roadway traffic computing device 110, weather computing device 112, and fixed route transportation network computing device 114 may be connected to the shuttle management computing device 108 over one or more wired or wireless networks 106 using communication protocols known in the art. Similarly, the shuttle management computing device 108 may be connected to each user device (e.g., user device 102a) of the user device(s) 102 and each shuttle (e.g., shuttle 104a) of the fleet of shuttles 104 via the one or more wired or wireless networks 106.

Each user device (e.g., user device 102x) of the user device(s) 102 may constitute any suitable electronic device capable of communicating with the shuttle management computing device 108 over the network(s) 106. By way of example and not limitation, the user device(s) 102 may include smart phones, tablets, mobile phones, laptop computers, desktop computers, personal digital assistants, e-readers or any other suitable electronic device known in the art and capable of performing the functions described herein.

Each shuttle (e.g., shuttle 104x) of the fleet of shuttles 104 may constitute any suitable vehicle capable (i) communicating with the shuttle management computing device 108 over the network(s) 106 and (ii) transporting one or more passengers from a first location (e.g., a pick-up location) to a second location (e.g., a destination or “drop-off” location). According to some examples, the shuttles may include cars, vans, buses, bicycles, motorcycles, trains, trams, ferries, etc. According to one example, the fleet 104 includes autonomous vehicles configured to travel along a particular route and/or make particular stops based on instructions received from the shuttle management computing device 108.

The roadway traffic computing device 110 may include one or more computing devices (e.g., server computers or the like) connected to the shuttle management computing device 108 over the network(s) 106. According to one example, the roadway traffic computing device 110 may be configured to generate traffic information associated with a geographic location encompassing a pick-up location received as part of a shuttle reservation request from a user device (e.g., user device 102a). The traffic information may include a description of traffic conditions on one or more roadways within the geographic location. According to one example, the geographic location may additionally encompass the destination or drop-off location received as part of the shuttle reservation request from the user device. Furthermore, the traffic conditions may be expressed quantitatively (e.g., on a scale of 1 to 10 with 1 being light traffic conditions and 10 being heavy traffic conditions), qualitatively (e.g., “light,” “moderate,” or “heavy”), or via any other suitable convention known in the art.

The weather computing device 112 may include one or more computing devices (e.g., server computers or the like) connected to the shuttle management computing device 108 over the network(s) 106. According to one example, the weather computing device 112 may be configured to generate weather information associated with a geographic location encompassing a pick-up location received as part of a shuttle reservation request from a user device (e.g., user device 102a). The weather information may include a description of weather conditions in and/or around the geographic location. According to one example, the geographic location may additionally encompass the destination or drop-off location received as part of the shuttle reservation request from the user device. Furthermore, the weather conditions may be expressed quantitatively (e.g., via one or more temperature, pressure, and/or humidity readings), qualitatively (e.g., “rain,” “hail,” “sleet,” “snow,” “high wind,” “extreme heat,” “extreme cold,” etc.), or via any other suitable convention known in the art.

The fixed route transportation network computing device 114 may include one or more computing devices (e.g., server computers or the like) connected to the shuttle management computing device 108 over the network(s) 106. According to one example, the fixed route transportation network computing device 114 may be configured to generate fixed route transportation state information describing respective statuses of vehicles included within a fixed route transportation network associated with the geographic location encompassing the pick-up location (or, in some examples, the destination or drop-off location as well) received as part of a shuttle reservation request from a user device (e.g., user device 102a). The vehicles included within the fixed route transportation network may include vehicles that operate according to predetermined schedules as part of a fixed route transportation network such as, but not limited to, trains, buses, ferries, planes, etc. The fixed route transportation state information may include descriptions of the states, or statuses, of the vehicles included within the fixed route transportation network associated with the geographic location. The fixed route transportation state information may indicate, by way of example and not limitation, whether the vehicles are running on time or experiencing a delay, the projected length of any delay, the nature of any event or events causing any delay, etc.

The traffic information, weather information, and/or fixed route transportation state information may be collectively referred to as “transportation network state information 116” herein. As discussed in further detail below, the transportation network state information 116 may be utilized by the shuttle management computing device 108 to (i) optimize and dynamically adjust management of the fleet 104 and (ii) improve user experience by, among other things, providing highly accurate projected destination arrival times.

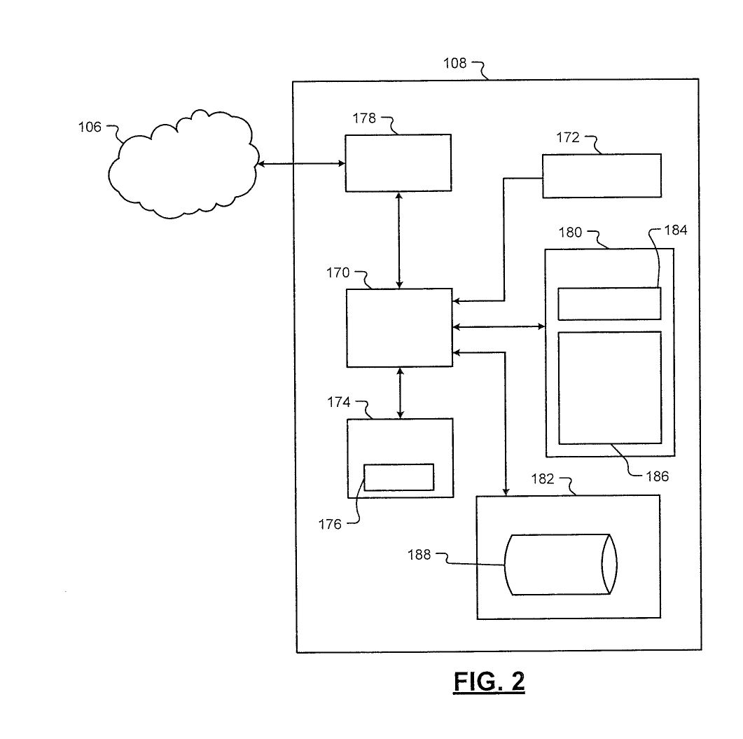

FIG. 2 shows an example of a computing device 108. For simplicity, only a single computing device 108 is depicted in FIG. 2, however, it is understood that the distributed network system 100 of FIG. 1 may include one or more computing devices 108 adopting the same or a similar architecture to that set forth with regard to the computing device 108 of FIG. 2. In one example, the computing device 108 is a server computer. The computing device 108 typically includes one or more CPUs or processors 170, one or more input devices 172 (e.g., a keypad, touchpad, mouse, and so on), a display subsystem 174 including a display 176, a network interface 178, a memory 180, and a bulk storage 182.

The network interface 178 connects the computing device 108 to the distributed network system 100 via the network 106. For example, the network interface 178 may include a wired interface (e.g., an Ethernet interface) and/or a wireless interface (e.g., a Wi-Fi, Bluetooth, near field communication (NFC), or other wireless interface). The memory 180 may include volatile or nonvolatile memory, cache, or other type of memory. The bulk storage 182 may include flash memory, one or more hard disk drives (HDDs), or other bulk storage device.

The processor 170 of the computing device 108 executes an operating system (OS) 184 and a fleet management application 186 configured to, among other things, generate and transmit shuttle route information to shuttles in the fleet, generate and transmit one or more reservation confirmations to one or more user devices, and perform additional functions as discussed more fully below. The bulk storage 182 may store one or more databases 188 that store data structures used by the fleet management application 186 to perform respective functions. In one example, the computing device 108 may be utilized to control one or more autonomous vehicles included as part of the shuttle fleet.

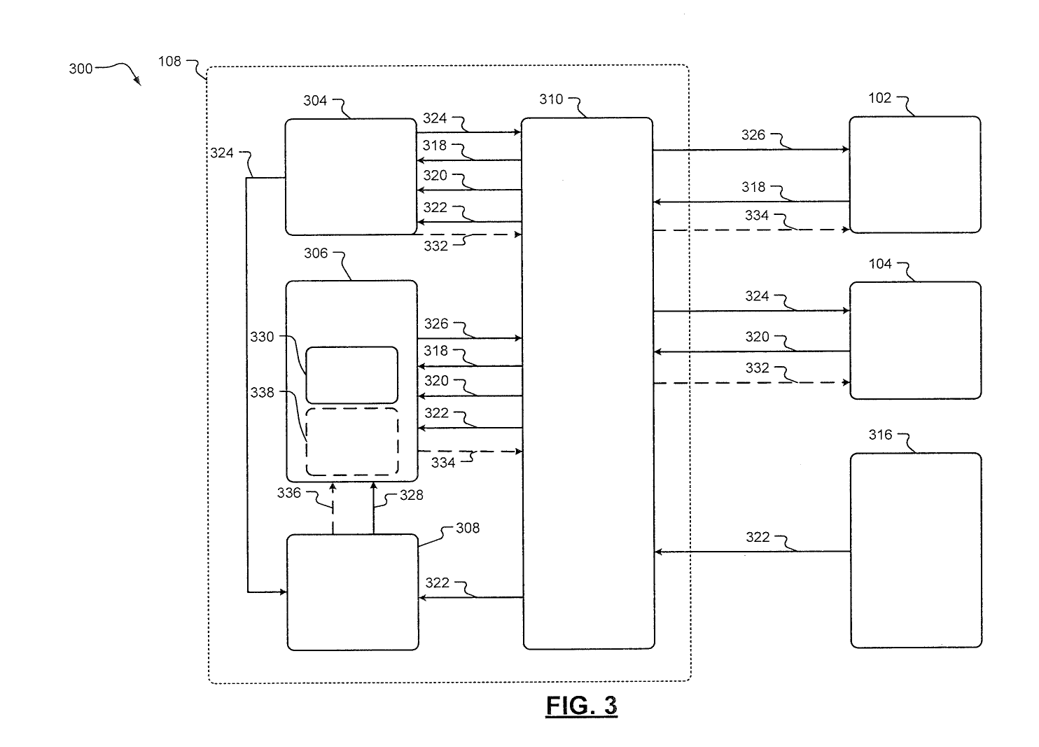

Referring now to FIG. 3, another example of a system 300 for managing a fleet of shuttles 314 is shown. In one example, the computing device 108 of the system may be implemented as executing the fleet management application 186 described above with regard to FIG. 2. Similarly, the computing device 108 may be communicatively connected to the user device(s) 102, fleet of shuttles 104, and/or traffic, weather, and fixed route information sources 316 via one or more networks, such as the network(s) 106 described above with regard to FIGS. 1-2. According to one example, the traffic, weather, and fixed route information sources 316 may be implemented as the roadway traffic computing device 110, weather computing device 112, and fixed route transportation network computing device 114 described above with regard to FIG. 1.

The computing device 108 includes a shuttle assignment module 304, a reservation confirmation module 306, a buffer generation module 308, and a communications module 310. The computing device 108 is configured to operate as follows.

The communications module 310, which may be implemented as a transceiver or the like under the control of suitable logic, is configured to obtain (i.e., fetch or receive) a shuttle reservation request 318 from a user device of the one or more user devices 102. The shuttle reservation request 318 may include a target destination arrival time, a pick-up location, and/or a destination location. The target destination arrival time may describe a particular time (or, according to some examples, a window of time) at which the one or more users placing the request 318 would like to be dropped off at their destination by a shuttle of the fleet 104. The pick-up location may describe a location where the one or more users placing the request 318 would like to be picked up by a shuttle of the fleet 104, and may be expressed in terms of a textual address, textual geolocation coordinates (e.g., GPS coordinates, latitudinal/longitudinal coordinates, etc.), and/or visual geolocation coordinates (e.g., as expressed from a “pick-up location” indicator on a digital map). Similarly, the destination location may describe a location where the one or more users placing the request 318 would like to be dropped off by a shuttle of the fleet 104, and may be expressed in terms of a textual address, textual geolocation coordinates (e.g., GPS coordinates, latitudinal/longitudinal coordinates, etc.), and/or visual geolocation coordinates (e.g., as expressed via a “drop-off location” indicator on a digital map).

The communications module 310 may be further configured to obtain shuttle information 320 from each shuttle in the shuttle fleet 104. The shuttle information 320 may include identity information, location information, occupancy information, and/or seating configuration information associated with each shuttle in the shuttle fleet 104. The identity information may include information sufficient to uniquely identify each shuttle in the fleet 104 such as, but not limited to, VIN number, license plate number, make and model, color, etc. The location information may include information describing a current location of each shuttle in the fleet 104 and/or current route information describing where each vehicle in the fleet 104 is currently heading. The location information may be expressed in terms of a textual address, textual geolocation coordinates (e.g., GPS coordinates, latitudinal/longitudinal coordinates, etc.), and/or visual geolocation coordinates (e.g., as expressed via a “shuttle location” indicator on a digital map). The occupancy information may include information describing a current or projected occupancy of each vehicle in the fleet 104 (e.g., how many seats are occupied and/or how many seats are available). For example, and as described in further detail below, according to some implementations, the system 300 may operate in a ride-sharing mode whereby multiple passengers associated with separate shuttle reservation requests may share a shuttle for a portion or all of their trip. The seating configuration information may include information describing possible seating arrangements for each vehicle in the fleet 104. For example, the seating configuration information may indicate that a given shuttle has foldable seats that may be folded to provide additional room within shuttle's cabin. According to other examples, the seating configuration information may indicate whether or not a given shuttle is wheelchair accessible or includes child-seats.

In addition, the communications module 310 may be configured to obtain transportation network state information 322 from the traffic, weather, and fixed route information sources 315. The transportation network state information 322 may include traffic information, weather information, and/or fixed route transportation state information consistent with the descriptions of those types of information provided above.

The shuttle assignment module 304 is configured to obtain the shuttle reservation request 318, shuttle information 320, and transportation network state information 322 from the communications module 310 and perform further processing based thereon. More specifically, according to one example, the shuttle assignment module 304 is configured to generate shuttle route information 324 based on the shuttle reservation request 318, the shuttle information 320 (including, in some examples, the seating configuration information), and the transportation network state information 322. The shuttle route information 324 includes an instruction directing a shuttle of the fleet 104 to pick-up one or more passengers (e.g., the one or more passengers associated with the user device that issued the shuttle reservation request 318) at the pick-up location and transport the passenger(s) to the destination location by the target destination arrival time.

According to some examples where one or more shuttles in the fleet 104 constitute autonomous vehicles (e.g., self-driving cars), the shuttle route information 324 may be configured to cause at least one of the autonomous vehicles to pick-up the passenger at the pick-up location and transport the passenger to the destination location by the target destination arrival time.

According to another example, the shuttle assignment module 304 is further configured to select a particular shuttle from the shuttle fleet 104 to satisfy the shuttle reservation request 318. The selection may be based on the shuttle reservation request 318, the shuttle information 320, and/or the transportation network state information 322. In one implementation, the shuttle assignment module 304 may select the particular shuttle from the shuttle fleet 104 prior to, or as part of, generating the shuttle route information 324. In this manner, the shuttle assignment module 304 may direct the shuttle route information 324 to the appropriate shuttle in the fleet 104. The communication module 310 may be configured to transmit the shuttle route information 324 to the proper shuttle following the selection.

In one implementation, the shuttle assignment module 304 is configured to dynamically react to changes to any of the shuttle reservation request 318, the shuttle information 320, and/or the transportation network state information 322 to ensure optimal shuttle assignment and routing. More specifically, the shuttle assignment module 304 may be configured to generate updated shuttle route information 332 based on a change to at least one of the shuttle reservation request 318, the shuttle information 320, and/or the transportation network state information 322. In such an implementation, the communications module 310 may be configured to transmit the updated shuttle route information 332 to the shuttle(s). The updated shuttle route information 332 may modify previously transmitted shuttle route information 324 in some manner, such as, for example, by instructing the shuttle(s) to take a different route to pick-up and/or drop-off one or more passengers.

The reservation confirmation module 306 is configured to obtain the shuttle reservation request 318, shuttle information 320, and transportation network state information 322 from the communications module 310 and perform further processing based thereon. More specifically, according to one example, the reservation confirmation module 306 is configured to determine a projected destination arrival time 330 based on the shuttle reservation request 318, shuttle information 320, and transportation network state information 322. The projected destination arrival time 330 may indicate when a given user can expect to arrive at the destination location indicated as part of the shuttle reservation request 318. In one example, the projected destination arrival time 330 may be the same as the target destination arrival time. However, in other examples, the projected destination arrival time 330 may be different than the target destination arrival time indicated as part of the shuttle reservation request 318.

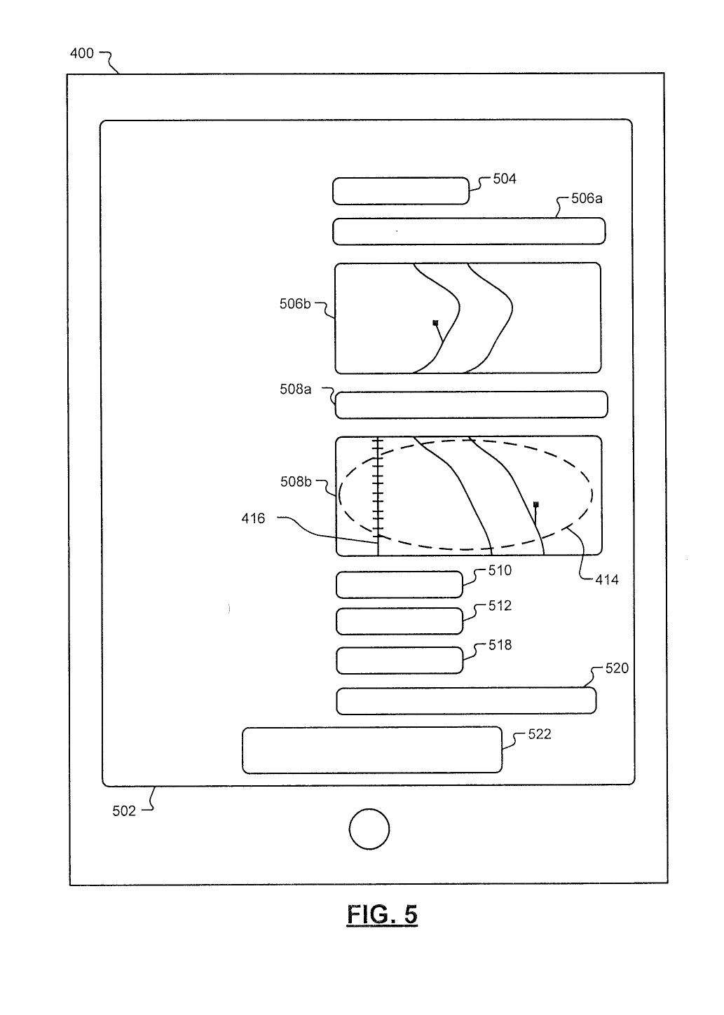

Furthermore, the reservation confirmation module 306 is configured to generate a reservation confirmation 326 including, at a minimum, the projected destination arrival time 330. In other examples, the reservation confirmation 326 may include additional information beyond the projected destination arrival time 330. For instance, in one implementation, the reservation confirmation 326 may include assigned shuttle identify information. The assigned shuttle identify information may include information identifying a particular shuttle from the shuttle fleet 104 assigned to satisfy the reservation request 318. According to another example, the reservation confirmation 326 may include pick-up location confirmation information. The pick-up location confirmation information may include a textual and/or visual representation of the pick-up location. Various implementations of the reservation confirmation 326 are illustrated and described in further detail herein with regard to FIG. 5.

In one implementation, the reservation confirmation module 306 is configured to dynamically react to changes to any of the shuttle reservation request 318, the shuttle information 320, and/or the transportation network state information 322 to keep users abreast of circumstances that may impact, for example, the projected destination arrival time 330. More specifically, the reservation confirmation module 306 may be configured to determine an updated projected destination arrival time 338 based on a change to at least one of the shuttle reservation request 318, the shuttle information 320, and/or the transportation network state information 322. In addition, the reservation confirmation module 306 may be configured to generate an updated reservation confirmation 334 that includes the updated projected destination arrival time 338. In such an implementation, the communications module 310 may be configured to transmit the updated reservation confirmation 334 to the user device(s) 102. The updated reservation confirmation 334 may modify a previously transmitted reservation confirmation 326 in some manner, such as, for example, by indicating the updated projected destination arrival time 338.

The buffer generation module 308 is configured to obtain the shuttle route information 324 from the shuttle assignment module 304, and obtain the transportation network state information 322 from the communications module 310 and perform further processing based thereon. More specifically, according to one example, the buffer generation module 308 is configured to generate a buffer time 328 based on the shuttle route information 324 and the transportation network state information 322. The buffer time 328 is designed to project possible delays associated with a trip based on the shuttle route information 324 and the transportation network state information 322.

According to examples where one or more of the shuttles run on a fixed route between various stations, the buffer generation module 308 may be configured to generate respective buffer times 328 for each of the one or more stations. The buffer time(s) 328 may serve a variety of purposes as used within the system 300 described herein including, but not limited to: (i) setting expectations of the user (e.g., customer/rider); (ii) allow time for re-routing to other stations (e.g., in a fixed route model) to increase system efficiency (where the re-routing event may consume all or part of the buffer); and/or (iii) to account for traffic or other unexpected delays which may “eat into” the buffer. According to some examples, the buffer generation module 308 may generate the buffer time 328 using a logarithmic function based on a typical expected trip time (e.g., an expected trip time from a first station to a second station in a fixed route system based on historical data associated with the trip time).

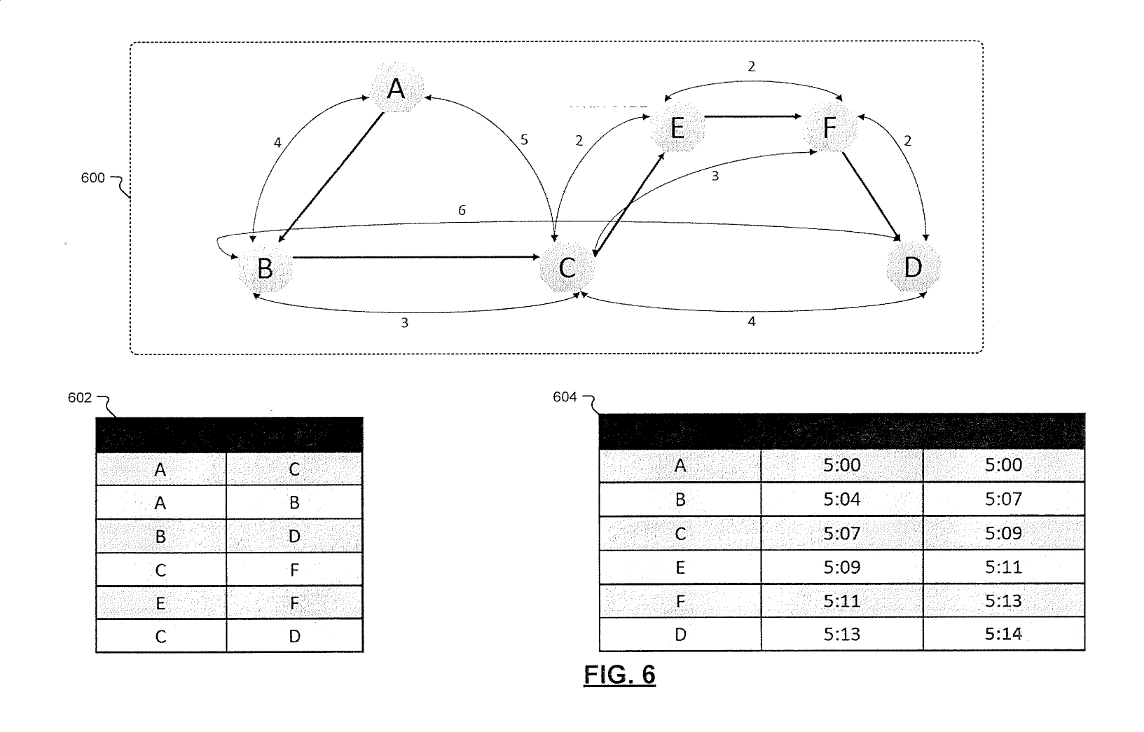

According to one example, the reservation confirmation module 306 is configured to determine the projected destination arrival time 330 based on the buffer time 328. For example, absent consideration of the buffer time 328, the reservation confirmation module 306 might determine a projected destination arrival time 330 of 7:00 pm. However, upon consideration of the buffer time 328, the reservation confirmation module 306 might determine a projected destination arrival time 330 of 7:05 pm. By accounting for potential delays in a trip, the buffer generation module 308 can enhance the user experience by presenting an attainable projected destination arrival time 330. Furthermore, although the preceding example described determining a finite projected destination arrival time 330 based on the buffer time 328, according to some examples (and as discussed in additional detail with reference to FIG. 6 below), the projected destination arrival time 330 may constitute a range such as an “expected arrival time” and a “maximum arrival time.”

In one implementation, the buffer generation module 308 is configured to dynamically react to changes to any of the shuttle route information 324 and/or the transportation network state information 322 to improve upon the accuracy of any projected destination arrival time 330. More specifically, the buffer generation module 308 may be configured to generate an updated buffer time 336 based on a change to at least one of the shuttle route information 324 and/or the transportation network state information 322. In line with this implementation, the reservation confirmation module 306 may be further configured to determine an updated projected destination arrival time 338 based on the updated buffer time 336. Further, the reservation confirmation module 306 may be configured to generate an updated reservation confirmation 334 that includes the updated projected destination arrival time 338. The communications module 310 may be configured to transmit the updated reservation confirmation 334 to the user device(s) 102.

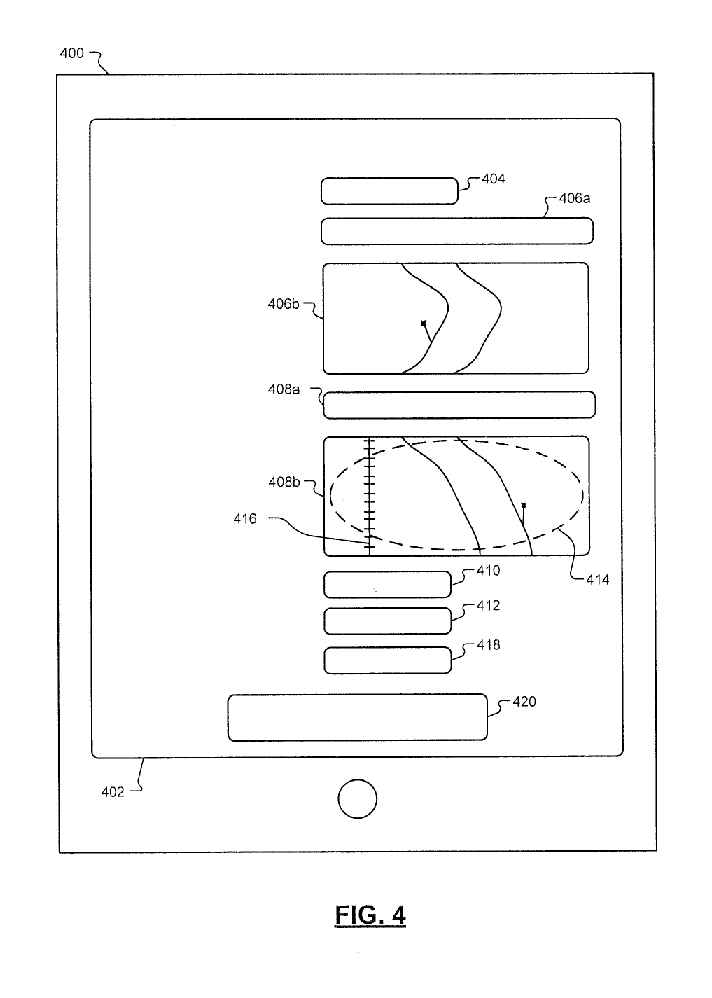

Turning now to FIG. 4, one example of a user device 400 including a graphical user interface (GUI) 402 configured to facilitate the placing of a shuttle reservation request by a user is shown. The user device 400 may include any suitable electronic device, such as the types of electronic devices described with regard to the user device(s) 102 above. The GUI 402 may accept input via any suitable mechanisms known in the art including, but not limited to, via a touchscreen interface, stylus, keyboard, mouse, etc., or any combination thereof. The GUI 402 is configured to output display information and obtain input from a user. In this manner, a user may utilize the GUI 402 to configure the parameters of, and issue, a shuttle reservation request.

The GUI 402 includes several configurable parameters. For example, the GUI 402 includes a target destination arrival time field 404. This field 404 allows a user to input a specific time that they would like arrive at their destination. In addition, the GUI 402 includes a textual destination location input field 406a and/or a map-based destination location input field 406b. A user may textually enter the destination location (e.g., as an address, an intersection, a landmark, via geolocation coordinates, etc.) via the textual destination location input field 406a. Additionally, or alternatively, a user may identify the destination location via the map-based destination location input field 406b by selecting a point on the digital map. Selection may occur via use of a touchscreen interface, stylus, keyboard, mouse, etc., or any combination thereof, using selection techniques known in the art.

The GUI 402 also includes a textual pick-up location input field 408a and/or a map-based pick-up location input field 408b. A user may textually enter the pick-up location (e.g., as an address, an intersection, a landmark, via geolocation coordinates, etc.) via the textual pick-up location input field 408a. Additionally, or alternatively, a user may identify the pick-up location via the map-based pick-up location input field 408b by selecting a point on the digital map. Selection may occur via use a touchscreen interface, stylus, keyboard, mouse, etc., or any combination thereof, using selection techniques known in the art. The map-based pick-up location input field 408b also illustrates a number of other features described above. For example, the map-based pick-up location input field 408b illustrates a geographic region 414 encompassing the pick-up location. As described above, according to some implementations, the system described herein (e.g., as implemented via the computing device 108) may perform shuttle selection and/or route assignment based on weather conditions, traffic conditions, and/or fixed route transportation state information associated with the geographic region 414 encompassing the pick-up location (and, in some instances, additionally, or alternatively, encompassing the destination location).

Further, the map-based pick-up location input field 408b illustrates one example of a fixed route transportation network in the form of train tracks 416. According to one example, the shuttle system may be aware of the states of trains traveling along the train tracks 416, and may modify features, such as shuttle selection and/or route assignment, to satisfy a shuttle reservation request. For example, the shuttle management system described herein may select a first shuttle to satisfy a reservation request over a second shuttle, even though the second shuttle is closer in proximity to the pick-up location. This could be, for example, because the shuttle management system knows that the second shuttle will have to stop to allow a train to pass on its way to the pick-up location, such that the second shuttle would take longer to arrive at the pick-up location than the first shuttle, despite being in closer proximity to the pick-up location than the first shuttle. Similarly, the shuttle management system described herein may utilize knowledge of fixed route transportation systems to assign a particular route to a shuttle. For example, and returning to the train example, the shuttle management system may be configured to assign a route (e.g., to a pick-up location or a destination location) that is not necessarily the shortest distance from the beginning point to the end point, but that is the quickest route, nonetheless, because it avoids things like needing to stop to allow a train to pass.

The number of passengers input field 410 of the GUI 402 allows a user to identify the number of passengers that will be traveling from the pick-up location to the destination location. The system may utilize this information, for example, for shuttle selection and/or route assignment. With regard to shuttle selection, the system may use the “number of passengers” information to ensure that the assigned shuttle has sufficient occupancy. Occupancy for a given shuttle may be determined based on, for example, the number of current passengers in a given shuttle (e.g., as determined via suitable occupancy sensors located in the shuttle) and/or seating configuration information, which may indicate that a shuttle's seating arrangement may be reconfigured (e.g., by folding down, moving, adding, or removing seats) to accommodate additional passengers.

The wheelchair access needed input field 412 of the GUI 402 allows a user to indicate whether wheelchair access is needed by any of the passengers. The system may utilize this information, for example, for shuttle selection to ensure that the assigned shuttle is wheelchair accessible.

The number of children passengers input field 418 of the GUI 402 allows a user to indicate whether any children will be included as passengers. The system may utilize this information, for example, for shuttle selection. For example, it may be important to select a shuttle that includes child-safety seats or the like if children will be riding. Similarly, knowledge of whether children will be passengers may be utilized to assess occupancy, because children generally occupy less space than adults.

Finally, the issue shuttle request button 420 allows a user to finalize their shuttle reservation request. Once a user selects the issue shuttle request button 420 (using any selection technique known in the art), the shuttle reservation request (along with its associated parameters) may be transmitted from the user device 400 to the shuttle management system described herein (e.g., as implemented via the computing device 108).

Turning now to FIG. 5, another example of the user device 400 including a graphical user interface (GUI) 502 configured to confirm a user's shuttle reservation request is shown. The GUI 502 may accept input via any suitable mechanisms known in the art including, but not limited to, via a touchscreen interface, stylus, keyboard, mouse, etc., or any combination thereof. The GUI 502 is configured to output display information and, in some instances, obtain input from a user. In this manner, a user may utilize the GUI 502 to view their shuttle reservation for accuracy and/or cancel or modify a previously placed shuttle reservation request.

The GUI 502 includes a projected destination arrival time field 504. Note that while the target destination arrival time was set as 7:00 pm EST (see the target destination arrival time input filed 404 of FIG. 4), the projected destination arrival time is set at 7:05 pm EST. This is because, in this example, the system determined a projected arrival time (in accordance with the process for making such a determination set forth above) that differs from the user's target destination arrival time. Although the example shown in FIG. 5 illustrates the projected destination arrival time being later than the target destination arrival time, in some examples, the target destination arrival time and the projected destination arrival time could be the same, or the projected destination arrival time could be earlier than the target destination arrival time. In addition, and as discussed above, in some examples, the projected destination arrival time may be based, at least in part, on a buffer time. The projected destination arrival time field 504 is generally not user configurable.

The destination location field 506a of the GUI 502 textually indicates the destination location associated with the shuttle reservation request and, according to some implementations, may be edited by the user (e.g., to correct for an error in the destination location entered into the textual destination location input field 406a of FIG. 4). Similarly, the map-based destination location field 506b visually indicates the destination location associated with the shuttle reservation request and, according to some implementations, may be edited by the user (e.g., to correct for an error in the destination location entered into the map-based destination location input field 406b of FIG. 4).

The pick-up location field 508a of the GUI 502 textually indicates the pick-up location associated with the shuttle reservation request and, according to some implementations, may be edited by the user (e.g., to correct for an error in the pick-up location entered into the textual pick-up location input field 408a of FIG. 4). Similarly, the map-based pick location field 508b visually indicates the pick-up location associated with the shuttle reservation request and, according to some implementations, may be edited by the user (e.g., to correct for an error in the pick-up location entered into the map-based pick-up location input field 408b of FIG. 4). In addition, the map-based pick-up location field 508b illustrates the geographic region 414 encompassing the pick-up location and the train tracks 416 discussed above with regard to FIG. 4.

The number of passengers field 510 of the GUI 502 identifies the number of passengers that are confirmed for the shuttle reservation request and, according to some implementations, may be edited by the user (e.g., to correct for an error in the number of passengers entered into the input field 410 of FIG. 4).

The wheelchair access needed field 512 of the GUI 502 identifies whether the shuttle that is assigned to satisfy the reservation request must be wheelchair accessible and, according to some implementations, may be edited by the user (e.g., to correct for an error in the wheelchair access needed input field 412 of FIG. 4).

The number of children passengers field 518 of the GUI 502 identifies the number of children passengers that are confirmed for the shuttle reservation request and, according to some implementations, may be edited by the user (e.g., to correct for an error in the number of children passengers entered into the input field 418 of FIG. 4).

The assigned shuttle ID field 520 provides identification information associated with the assigned shuttle. Such information may include, but is not limited to, a VIN number, license plate number, make and model, color, etc. The assigned shuttle ID field 520 is generally not user configurable.

Finally, the cancel shuttle request button 522 allows a user to cancel their shuttle reservation request. Once a user selects the cancel shuttle request button 522 (using any selection technique known in the art), the cancellation may be transmitted from the user device 400 to the shuttle management system described herein (e.g., as implemented via the computing device 108).

Referring now to FIG. 6, a state diagram 600 and accompanying tables 602, 604 illustrating an example of a process for managing multiple shuttle reservation requests across a fixed route transportation network is shown. The state diagram 600 illustrates an exemplary route taken by a shuttle across stations A through F as part of a fixed route transportation network. The Reservation Requests table 602 illustrates the order of reservation requests (from top to bottom), the requested pick up points (left column) and the requested drop off points (right column) for each reservation request. The Shuttle 1 Route table 604 illustrates expected arrival times (middle column) and maximum arrival times (right-most column) for each station (left-most column) in the network based on the reservation requests.

The chronological order of the reservations, as they were made, is displayed in the Reservation Requests table 602 (with the top request being first in time and the bottom request being last in time). Note that the first request was from A to C, and the second request was from A to B. This raises the question of, why is the route not from A to C to A to B? This is because, according to this example, the system (e.g., as implemented by the computing device 108) recognizes the common “A” stop, checks the capacity of the shuttle, and decides to combine them. However, this raises an additional question of why the route is not from A to C to B, given that the A to C request was made first? This is because, according to this example, the system calculated that B was in between A and C, and therefore it was more efficient to travel from A to B to C. The foregoing schedule could raise the question of whether it would make the A to C reservation late, because that trip is going to be interrupted with travel to station B. However, the A to C reservation is not interpreted as late, because a buffer time was generated to account for such a delay, so from the passenger's viewpoint, the trip was on time.

The following reflects a summary of the shuttle's route according to the state diagram 600 and tables 602, 604 of FIG. 6. A first reservation from station A to station C is established, the shuttle Route is from station A to station C, and the buffer time is set on station C for 4 additional minutes. The departure time of the shuttle from station A is 5:00, arrival time for station C is 5:05 (buffer maximum arrival time 5:09).

A second reservation from A to B is established, the system re-routed the shuttle using the buffer on station C, and decides to go to Station B and then to Station C, buffer of 3 minutes is set on Station B (for this route we have used 2 two minutes of the buffer on Station C). The new shuttle route is Station A 5:00, Station B 5:05 (buffer 5:07), Station C 5:07 (buffer 5:09).

A third reservation from B to D is established, the system decides to add the stop to the end of the route, and a buffer is set on Station D of 3 minutes. The new shuttle route is Station A 5:00, Station B 5:04 (buffer 5:07), Station C 5:07 (buffer 5:09), and Station D 5:11 (buffer 5:14).

A fourth reservation from C to F is established, the system decides to re-route the shuttle and add a stop at F between station C and station D, using 1 minute of the buffer on station D, the buffer is set on station F for 3 minutes. The new shuttle route is Station A 5:00, Station B 5:04 (buffer 5:07), Station C 5:07 (buffer 5:09), Station F 5:10 (buffer 5:13), Sand tation D 5:12 (buffer 5:14).

A fifth reservation from E to F is established, the system decides to re-route the shuttle and add a stop at E between station C and station F using 1 minute of the buffer on Station F and 1 minute of the buffer on station D, and the buffer is set on Station E for 2 minutes. The new shuttle route is Station A 5:00, Station B 5:04 (buffer 5:07), Station C 5:07 (buffer 5:09), Station E 5:09 (5:11), Station F 5:11 (buffer 5:13), and Station D 5:13 (buffer 5:14).

Finally, a last reservation is established from C to D, the system decides the preferred option is to use the current route because station C and station D are already part of the route, departure time for station C 5:07 and arrival time for station D 5:13, route does not change and the buffer does not change at any of the stations.

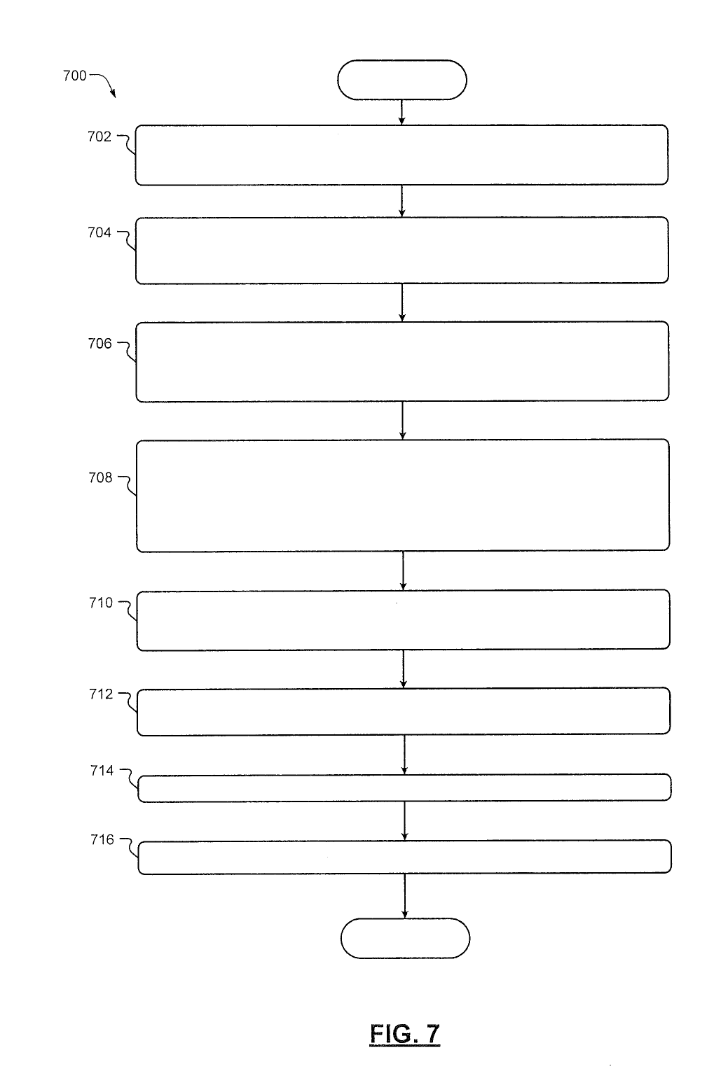

Referring now to FIG. 7, a flowchart illustrating a method 700 for managing a shuttle fleet is provided. The method 700 beings at 702 where a shuttle reservation request is obtained from a user device. The shuttle reservation request may include at least a target destination arrival time, a pick-up location, and a destination location. At 704, shuttle information is obtained from each shuttle in a shuttle fleet. The shuttle information may include identity information, location information, and occupancy information associated with each shuttle in the shuttle fleet. At 706, transportation network state information is obtained. The transportation network state information may include traffic information and weather information associated with a geographic region encompassing the pick-up location.

At 708, shuttle route information may be generated based on the shuttle reservation request, the shuttle information, and the transportation network state information. The shuttle route information may include an instruction directing a shuttle to pick-up a passenger at the pick-up location and transport the passenger to the destination location by the target destination arrival time. At 710, a projected destination arrival time is determined based on the shuttle reservation request, the shuttle information, and the transportation network state information. At 712, a reservation confirmation is generated. The reservation confirmation may include the projected destination arrival time. At 714, the shuttle route information is transmitted to the shuttle. At 716, the reservation confirmation is transmitted to the user device. Following 716, the method 700 concludes.

Among other features, the systems and methods described herein may provide the following capabilities. A fleet management system (e.g., implemented via the computing device 108) with full knowledge of the entire transportation network for every reservation request (and for every other system “event”). Because of the full knowledge of the transportation network, a reservation request (or other event, such as a delay) can be optimized by selecting the preferred (e.g., best) options for that customer or the transportation system (whether preferred is defined as fastest or most efficient).

Further, each event in the system (i.e., a trip from point A to B, the shuttle stopping to drop someone off, etc.) has a projected destination arrival time, but also may include a buffer time, which may be calculated dynamically based on a type of event, a state of the transportation network, and other factors. The buffer time may be used, for example, for shuttle routing, providing users with achievable projected arrival times to improve user satisfaction, etc.

In addition, the systems and methods of the present disclosure support adjustable efficiency ratio by campus or per reservation. For example, the system allows campuses (e.g., the City of Detroit) to adjust the amount of efficiency desired from their transportation network. The sliding scale is a choice between “first-come, first-serve” customer satisfaction versus a “utilitarian” (efficient) approach. This choice can be extended all the way down to the customer on a per-trip basis: do you want to pay $5, but it might take you 20 minutes to get to your destination, or will you pay $20 to get to your destination in 10 minutes?

Further still, the present system and methods provide dynamic re-routing and re-balancing of transportation network load, based on system events. When new capacity is introduced into the transportation network, the present system may rebalance the load of pending (upcoming) reservations onto the new capacity. When a transportation vehicle is running “late” beyond a certain threshold, the system may check the rest of the transportation network to see if there are better options for upcoming reservations. When the system is busy and users' choices for a trip become invalid (e.g., shuttle reservation requests cannot be satisfied), the system may attempt to find the next best choice trip within a certain range of time from the previous choice.

The present systems and methods also provide knowledge of fixed route schedules (internal and external to the system). That is, the present systems and methods provide integration between fixed route systems (which run on a loop, or a fixed schedule) and a dynamic transportation network, matching schedule times with dynamic pick-ups and drop-offs. Automatic adjustment of future “legs” of a trip may be provided when a prior leg is cancelled or delayed. Choices presented to users may include the best possible options from the aggregate/combination of each type of system. In addition, the present system may be configured to be a taxi service or ride share service.

According to some examples, the present system may implement pricing models based on how “rushed” the user is (e.g., a user pays more if they de-optimize the network). Pricing models implemented by the present system may be extremely flexible. For example, reservations may be priced based on one or more of the following variables: distance traveled, ride time, rider type, ride priority, flat rate, multi-zone rate, network de-optimization cost, transportation network supply/demand, etc. For example, a rider may pay a smaller amount for a longer trip. “Tiered” pricing model concepts may also be incorporated as part of the present system.

Furthermore, the present systems and methods utilize knowledge regarding dynamic vehicle capacity (e.g., whether shuts include interchangeable seat types, child seats, wheelchairs, etc.). This allows the present system to distinguish specific capacity requirements for each reservation, as well as match those requirements to a vehicle with that capacity capability. Vehicles can have fixed capacity and/or dynamic capacity (i.e., two regular seats fold-up to make room for a wheelchair).

According to some implementations, the present systems and methods may optimize shuttle scheduling and routing for arrival time, rather than departure time. For example, the present system may allow a user to designate their required departure time or their required arrival time. The system may further allow for future reservations within the same day.

The present systems and methods may also provide for the detection of users getting on and off of a shuttle. For example, according to some implementations, shuttles may be fitted within sensors (e.g., air bladder sensors disposed within seats) to detect the presence of one or more passengers in one or more of the seating areas (e.g., seats, areas for wheelchairs, etc.). In this manner, the system may allow for real-time occupancy information concerning each shuttle in the fleet, as well as for the detection of “no-shows.”

As mentioned above, the present system may be configured for use in connection with autonomous vehicles as he shuttles. The shuttles may act under command of the system to follow predetermined routes and make predetermined stops.

In some examples, the system may be multi-modal in that it may allow for one or more reservations in different transportation networks to be combined to create a trip, with automatic adjustments to each reservation when an event causes a shift or priority change in the system.

In some implementations, for example where the system is operating in a fixed route system with pre-designated pick-up and drop-off locations, the system may provide directions to users to get to the relevant pick-up or drop-off location. For example, the directions may indicate how to get between nodes/legs of a trip, how to get to the first pick-up node, how to get to a moving node (or a node position which is uncertain at first, but becomes more certain over time), etc.

According to some implementations, the system may operate with various zones and hubs. For example, campuses may be divided into zones, which are logical groupings of stations. These zones can separate shuttle operations, and provide hubs which allow transfers between nodes. Transfers between campuses are also possible with campus-to-campus hubs. Zones and campuses may also have physical boundaries, which may be used to provide automated administrative alerts, other restrictions, as well as having service level and pricing model implications.

In some examples, the system may provide for automated, systematic response to emergency events. For example, the system can respond to an emergency in a variety of ways. Due to full system knowledge, administrators/drivers/users can be notified, reservations can be cancelled, and shuttles can be diverted from “trouble” locations (areas, zones, stations, etc.) automatically.

Finally, the present systems and methods described herein may provide predictive capabilities. Traffic can vary based on date, time of day, holidays, weather, geographical location, transportation medium, and several other factors. The present system may more accurately predict estimated time of arrival (ETA) for reservations based on this data. Additional data about supply and demand, and driver and rider behavior may be captured to refine ETA times even further. Shuttle locations may also be predicted based on criteria such as, for example, reservation demand and/or time of day.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A system comprising:
a communications module configured to:
obtain a shuttle reservation request from a user device, wherein the shuttle reservation request comprises at least a target destination arrival time, a pick-up location, and a destination location;
obtain shuttle information from each shuttle in a shuttle fleet, wherein the shuttle information comprises identity information, location information, and occupancy information associated with each shuttle in the shuttle fleet; and
obtain transportation network state information, wherein the transportation network state information comprises traffic information and weather information associated with a geographic region encompassing the pick-up location;
a shuttle assignment module configured to:
generate shuttle route information based on the shuttle reservation request, the shuttle information, and the transportation network state information, wherein the shuttle route information comprises an instruction directing a shuttle to pick-up a passenger at the pick-up location and transport the passenger to the destination location by the target destination arrival time; and
a reservation confirmation module configured to:
determine a projected destination arrival time based on the shuttle reservation request, the shuttle information, and the transportation network state information; and
generate a reservation confirmation, wherein the reservation confirmation comprises the projected destination arrival time, and
wherein the communications module is further configured to:
transmit the shuttle route information to the shuttle; and
transmit the reservation confirmation to the user device.

2. The system of claim 1, further comprising:
a buffer generation module configured to:
obtain the shuttle route information and the transportation network state information; and
generate a buffer time based on the shuttle route information and the transportation network state information.

3. The system of claim 2, wherein the reservation confirmation module is further configured to determine the projected destination arrival time based on the buffer time.

4. The system of claim 2, wherein the buffer generation module is further configured to:
generate an updated buffer time based on a change to at least one of the shuttle route information and the transportation network state information.

5. The system of claim 4, wherein the reservation confirmation module is further configured to:
determine an updated projected destination arrival time based on the updated buffer time; and
generate an updated reservation confirmation, wherein the updated reservation confirmation comprises the updated projected destination arrival time.

6. The system of claim 5, wherein the communication module is further configured to:
transmit the updated reservation confirmation to the user device.

7. The system of claim 1, wherein the shuttle information comprises seating configuration information describing possible seating arrangements associated with each shuttle in the shuttle fleet.

8. The system of claim 7, wherein the shuttle assignment module is further configured to generate the shuttle route information based on the seating configuration information.

9. The system of claim 1, wherein the transportation network state information further comprises fixed route transportation state information describing respective statuses of vehicles included within a fixed route transportation network associated with the geographic region encompassing the pick-up location.

10. The system of claim 1, wherein the shuttle comprises an autonomous vehicle, and wherein the shuttle route information is configured to cause the autonomous vehicle to pick-up a passenger at the pick-up location and transport the passenger to the destination location by the target destination arrival time.

11. The system of claim 1, wherein the shuttle assignment module is further configured to:
select a particular shuttle from the shuttle fleet to satisfy the reservation request based on at least one of the shuttle reservation request, the shuttle information, and the transportation network state information.

12. The system of claim 1, wherein the reservation confirmation further comprises assigned shuttle identify information, and wherein the assigned shuttle identify information comprises information identifying a particular shuttle from the shuttle fleet assigned to satisfy the reservation request.

13. The system of claim 1, wherein the reservation confirmation further comprises pick-up location confirmation information, and wherein the pick-up location confirmation information comprises at least one of a textual and visual representation of the pick-up location.

14. The system of claim 1, wherein the reservation confirmation module is further configured to:
determine an updated projected destination arrival time based on a change to at least one of the shuttle reservation request, the shuttle information, and the transportation network state information.

15. The system of claim 14, wherein the reservation confirmation module is further configured to:
generate an updated reservation confirmation, wherein the updated reservation confirmation comprises the updated projected destination arrival time.

16. The system of claim 15, wherein the communications module is further configured to:
transmit the updated reservation confirmation to the user device.

17. The system of claim 1, wherein the shuttle assignment module is further configured to:
generate updated shuttle route information based on a change to at least one of the shuttle reservation request, the shuttle information, and the transportation network state information.

18. The system of claim 17, wherein the communication module is further configured to:
transmit the updated shuttle route information to the shuttle.

19. The system of claim 1, further comprising the shuttle.

20. The system of claim 1, further comprising the shuttle fleet.
